(19) United States
(12) Patent Application Publication
(10) Pub. No.: US 2010/0317475 A1
(43) Pub. Date: Dec. 16, 2010

(54) CHAIN GUIDE MOUNT FOR A BICYCLE

(75) Inventor: Jan Talavasek, Morgan Hill, CA (US)

Correspondence Address: MICHAEL BEST & FRIEDRICH LLP, 100 E WISCONSIN AVENUE, Suite 3300, MILWAUKEE, WI, 53202, US

(73) Assignee: SPECIALIZED BICYCLE COMPONENTS, INC., Morgan Hill, CA (US)

(21) Appl. No.: 12/483,405

(22) Filed: Jun. 12, 2009

(51) Int. Cl. F16H 55/36; B62M 3/00

(52) U.S. Cl. 474/141; 74/594.1

(57) ABSTRACT

A chain guide mount is adapted to be attached on a bicycle having a frame including a bottom bracket shell. A bottom bracket sleeve is position in the shell, and the sleeve includes a first anti-rotation feature. The chain guide mount has mounting locations for attachment of a chain guide, and further has a second anti-rotation feature engaging the first anti-rotation feature to thereby inhibit rotation of the chain guide mount relative to the sleeve. In one embodiment, the sleeve includes a cylindrical part position in the shell and a flange positioned outside the shell. In order to insure proper rotational orientation of the chain guide mount, the first and second anti-rotation features are preferably asymmetrically positioned around a bottom bracket axis defined by the bearing. In addition, a first alignment feature is provided on the frame, and the sleeve includes a second alignment feature engaging the first alignment feature.

### BACKGROUND

The present invention relates generally to bicycles, and more specifically to systems for mounting chain guides on bicycles.

Bicycles are commonly driven by a chain that engages front and rear sprockets for transferring power from the pedals to the rear wheel. On bicycles with multiple gears, a derailleur is frequently used to allow the chain to be moved to a different-sized sprocket to achieve a different gear ratio. In order to allow the chain to accommodate the various sprockets, the chain is over-sized and has slack. Typically, the derailleur is spring-loaded to take up the slack in the chain.

As a result of the chain slack, the chain has a tendency to bounce when riding the bicycle. This is particularly true when riding the bicycle over bumps, such as when riding on unpaved trails. When the bouncing of the chain is excessive, it can result in the chain disengaging from one of the sprockets (commonly called “derailing”), which is undesirable.

In order to alleviate the problem of chain derailing, bikes can be provided with “chain guides” that help to keep the chain in full engagement with the sprocket. Chain guides are commonly mounted to a special chain guide mount that is secured (e.g., welded, brazed, or clamped) to the frame of the bicycle.

### SUMMARY

When a chain guide mount is welded or brazed to the frame, it requires that the mount be installed onto the frame during the frame-manufacturing process. This can be a costly process, and is often performed on frames onto which the user never attaches a chain guide. In addition, chain guide mounts that are clamped to the frame can be aesthetically undesirable, and can damage the paint on the frame. Furthermore, clamped mounted could slip if not installed properly. Also, bike frames made from advanced fibers (e.g., carbon fiber) often do not easily provide locations for mounting accessories, and it is generally undesirable to clamp frame elements made from these materials.

The present invention provides a chain guide mount that is adapted to be attached on a bicycle having a frame including a bottom bracket shell. A bottom bracket sleeve is position in the shell, and the sleeve includes a first anti-rotation feature (e.g., a partially-cylindrical recess). The chain guide mount has mounting locations for attachment of a chain guide, and further has a second anti-rotation feature (e.g., a partially-cylindrical protrusion) engaging the first anti-rotation feature to thereby inhibit rotation of the chain guide mount relative to the sleeve. A bearing is coupled to the sleeve, and a bottom bracket spindle is rotationally supported by the bearing. This invention is particularly suitable for providing a chain guide mount on a bicycle having a carbon fiber frame.

The sleeve can be a single piece, or can include a first sleeve portion in telescoping engagement with a second sleeve portion. In one embodiment, the sleeve includes a cylindrical part position in the shell and a flange positioned outside the shell. Preferably, the flange includes a frustoconical surface, and the first anti-rotation feature is on the frustoconical surface. In order to insure proper rotational orientation of the chain guide mount, the first and second anti-rotation features are preferably asymmetrically positioned around a bottom bracket axis defined by the bearing.

In order to insure proper alignment of the first alignment feature with the frame, a first alignment feature (e.g., a protruding boss) is provided on the frame, and the sleeve includes a second alignment feature (e.g., a notch) engaging the first alignment feature.

Other aspects of the invention will become apparent by consideration of the detailed description and accompanying drawings.

### BRIEF DESCRIPTION OF THE DRAWINGS

FIG. 1 is a side view of a bicycle embodying the present invention.

FIG. 2 is an enlarged perspective view of a portion of the bicycle in FIG. 1.

FIG. 3. is an exploded view of the assembly shown in FIG. 2.

FIG. 4 is a section view taken along line 4-4 in FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

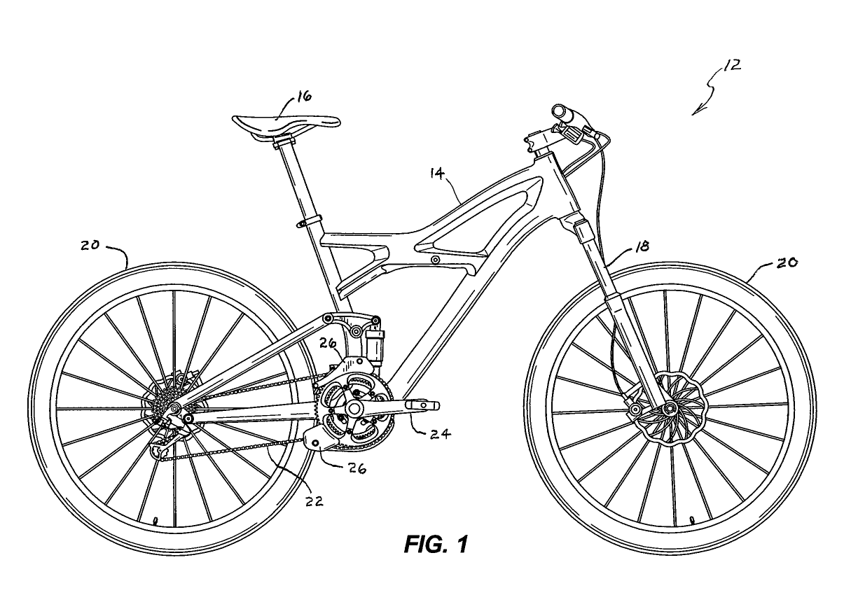

FIG. 1 illustrates a bicycle 12 having a carbon fiber frame 14, a seat 16 supported by the frame 14, a front fork 18 rotationally coupled to the frame 14, front and rear wheels 20 coupled to the frame 14, a chain 22, and a pedal and crank assembly 24 for providing power to the chain 22. A chain guide 26 is positioned adjacent to the chain 22 to inhibit the chain 22 from derailing.

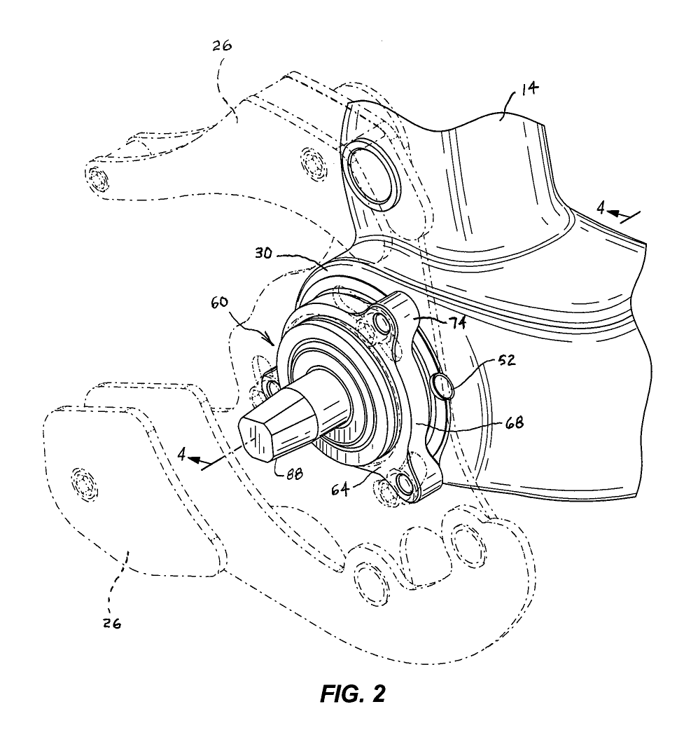

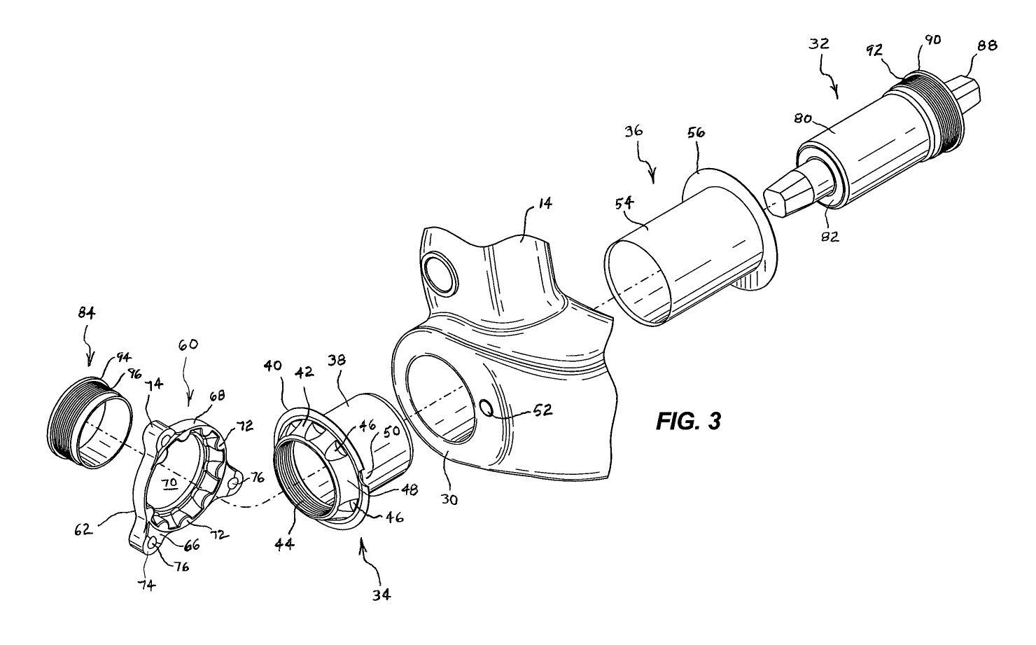

Referring to FIGS. 2-4, the frame 14 includes a bottom bracket shell 30 that supports a bearing assembly 32. In between the bottom bracket shell 30 and the bearing assembly 32, there is provided a bottom bracket sleeve secured to the shell 30. The illustrated sleeve includes a first sleeve portion 34 in telescoping engagement with a second sleeve portion 36. The first sleeve portion 34 includes a first cylindrical part 38 positioned inside the shell 30, and a first flange 40 positioned outside the shell 30. The first flange 40 includes a frustoconical surface 42 facing radially outward and a first threaded surface 44 facing radially inward and adapted to receive the bearing assembly 32, as described below in more detail. The frustoconical surface 42 includes a first anti-rotation feature in the form of a series of circumferentially-spaced recesses 46. Each recess 46 is in the shape of a partial cylinder. In addition, the recesses 46 are circumferentially asymmetrically positioned around the first sleeve portion 36. More specifically, as best shown in FIG. 3, there is a portion 48 of the frustoconical surface 42 where a recess is missing.

The above-described first sleeve portion 34 and shell 30 are provided with an alignment feature that ensures proper alignment of the first sleeve portion 34 relative to the shell 30. In the illustrated embodiment, the first sleeve portion 34 includes a first alignment feature in the form of a notch 50, and the shell 30 includes a second alignment feature in the form of a protruding boss 52. The illustrated boss 52 is substantially cylindrical in shape, and the illustrated notch 50 is semi-cylindrical. The boss 52 is dimensioned and positioned to fit within the notch 50 when the first sleeve portion 34 is properly positioned within the shell 30.

Similar to the first sleeve portion 34, the second sleeve portion 36 includes a second cylindrical part 54 positioned inside the shell 30, and a second flange 56 positioned outside the shell 30. The second sleeve portion 36 includes a second threaded surface 58 facing radially inward and adapted to receive the bearing assembly 32, as described below in more detail. Both the first sleeve portion 34 and the second sleeve portion 36 are secured in the bottom bracket shell 30, in any appropriate manner, such as by press fitting or bonding.

A chain guide mount 60 is positioned in engagement with the first sleeve portion 34. The chain guide mount 60 includes a base 62 having a front surface 64 (facing away from the shell 30), a rear surface 66 (facing toward the shell 30), and a radially exterior surface 68. The base 62 further includes a cylindrical opening 70 through its center. A series of circumferentially spaced protrusions 72 are formed on the rear surface 66. The protrusions 72 are partially cylindrical in shape and are circumferentially asymmetrically positioned around the opening 70 in a manner similar to the recesses 46 of the first sleeve portion 34. In this regard, the illustrated protrusions 72 are designed to fit within the recesses 46 in a single rotational orientation. It should be appreciated that the protrusions 72 and recesses 46 could be designed to allow multiple discreet rotational orientations between the chain guide mount 60 and the first sleeve portion 34.

The chain guide mount 60 further includes three mounting portions 74 positioned around the exterior surface 68. Each mounting portion 74 includes a hole 76 that facilitates the attachment of the chain guide 26 using appropriate fasteners, as is known in the art.

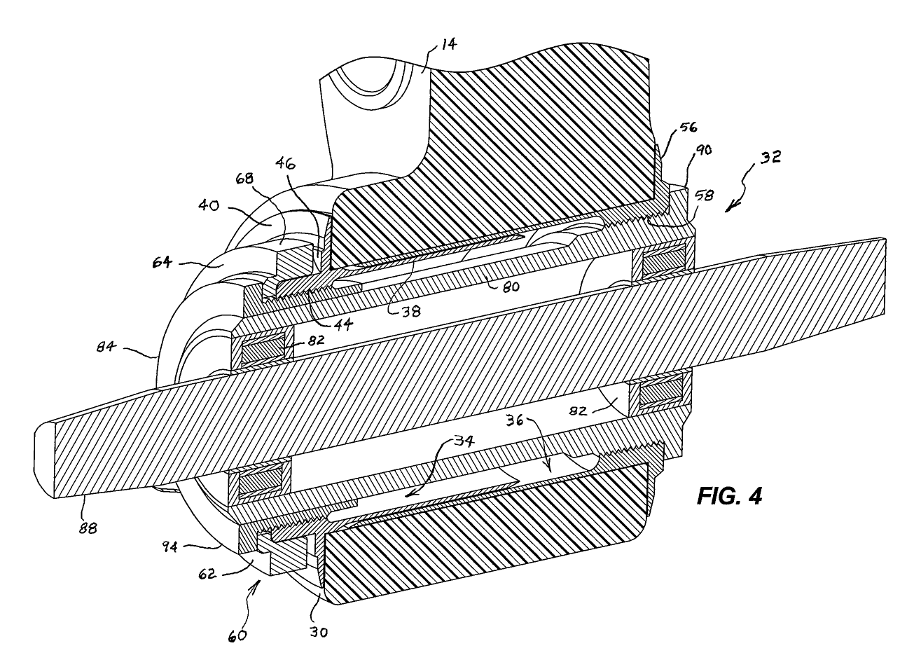

The bearing assembly 32 includes a bearing tube 80, two sealed bearings 82 press fit in the tube, a bearing cup 84 dimensioned to slide over an exterior surface of the bearing tube 80, and a spindle 88. These parts can be purchased as a single, pre-fabricated subassembly, as is known in the art. The bearing tube 80 includes an annular tube lip 90 and an external threaded surface 92 that is dimensioned to thread into the second threaded surface 58 of the second sleeve portion 36 until the tube lip 90 contacts the second flange 56. Similarly, the bearing cup 84 includes an annular cup lip 94 and an external threaded surface 96 that is dimensioned to thread into the first threaded surface 44 of the first sleeve portion 34. As shown in FIG. 4, the cup lip 94 is designed to sandwich the chain guide mount 60 against the first flange 40. The spindle 88 is rotationally supported by the bearings 82.

What is claimed is:

1. A bicycle comprising:
a frame including a bottom bracket shell;
a bottom bracket sleeve position in the shell, the sleeve including a first anti-rotation feature;
a chain guide mount having mounting locations for attachment of a chain guide, the chain guide mount further having a second anti-rotation feature engaging the first anti-rotation feature to thereby inhibit rotation of the chain guide mount relative to the sleeve;
a bearing assembly coupled to the sleeve; and
a bottom bracket spindle rotationally supported by the bearing assembly.

2. A bicycle as claimed in claim 1, wherein the sleeve includes a first sleeve portion in telescoping engagement with a second sleeve portion.

3. A bicycle as claimed in claim 1, wherein the frame includes a first alignment feature, and sleeve includes a second alignment feature engaging the first alignment feature

4. A bicycle as claimed in claim 3, first alignment feature comprises a protrusion and second alignment feature comprises a notch in which the protrusion is positioned

5. A bicycle as claimed in claim 1, wherein the sleeve includes a cylindrical portion position in the shell and a flange positioned outside the shell.

6. A bicycle as claimed in claim 5, wherein the flange includes a frustoconical surface.

7. A bicycle as claimed in claim 5, wherein the bearing assembly includes a lip, and wherein the chain guide mount is sandwiched between lip and the flange.

8. A bicycle as claimed in claim 1, wherein the first anti-rotation feature is on the flange.

9. A bicycle as claimed in claim 1, wherein the first anti-rotation feature includes a recess and the second anti-rotation feature includes a protrusion positioned in the recess.

10. A bicycle as claimed in claim 9, wherein the recess is substantially partially cylindrical in shape.

11. A bicycle as claimed in claim 1, wherein the spindle defines a bottom bracket axis, and wherein the first anti-rotation feature is asymmetrically disposed around axis.

12. A bicycle comprising:
a frame including a bottom bracket shell and a first alignment feature;
a bottom bracket sleeve position in the shell, the sleeve including a second alignment feature engaging the first alignment feature;
a chain guide mount having mounting locations for attachment of a chain guide;
a bearing assembly coupled to the sleeve; and
a bottom bracket spindle rotationally supported by the bearing assembly.

13. A bicycle as claimed in claim 12, wherein the first alignment feature comprises a protrusion and the second alignment feature comprises a notch in which the protrusion is positioned.

14. A bicycle as claimed in claim 13, wherein the protrusion comprises a substantially cylindrical boss and the notch comprises a substantially cylindrical shape dimensioned to receive the boss.

15. A bicycle as claimed in claim 13, wherein the protrusion is molded into the frame.

16. A bicycle as claimed in claim 12, wherein the sleeve includes a cylindrical portion positioned in the shell and a flange positioned outside the shell, and wherein the second alignment feature is on the flange.

17. A chain guide mount adapted to be mounted on a bicycle having a frame including a bottom bracket shell, and a bottom bracket bearing assembly, the chain guide mount including:
a base portion having a front surface, a rear surface, an exterior surface, an interior surface, and an opening adapted to receive the bearing;
a plurality of mounting portions secured around an exterior surface of the base portion; and
an anti-rotation feature positioned in the rear surface and adapted to engage a corresponding anti-rotation feature on the frame.

18. The chain guide mount as claimed in claim 17, wherein the base portion includes a frustoconical surface, and wherein the anti-rotation feature includes a protrusion.

19. The chain guide mount as claimed in claim 18, wherein the protrusion is substantially cylindrical in shape.

20. The chain guide mount as claimed in claim 17, wherein the opening defines a bottom bracket axis, and wherein the anti-rotation feature is asymmetrically disposed around axis.
